(19) United States
(12) Patent Application Publication
(10) Pub. No.: US 2018/0207658 A1
(43) Pub. Date: Jul. 26, 2018

(54) COMPACT CONTAINER HAVING SHORT STROKE PUMP AND RING BUTTON MEMBER

(71) Applicant: PUM-TECH KOREA CO., LTD, Incheon (KR)

(72) Inventor: Do Hoon LEE, Incheon (KR)

(21) Appl. No.: 15/748,032

(22) PCT Filed: Jul. 25, 2016
(86) PCT No.: PCT/KR2016/008085

§ 371 Date: Jan. 26, 2018

(30) Foreign Application Priority Data
Aug. 3, 2015 (KR) 10-2015-0109616

(51) Int. Cl. B05B 11/00; A45D 40/00; B65D 47/00; B65D 83/00

(52) U.S. Cl. CPC B05B 11/3001; B65D 83/00; B65D 47/00; A45D 40/00

(57) ABSTRACT

The present invention relates to a compact container having a short stroke pump and a ring button member and, more particularly, to a compact container having a short stroke pump and a ring button member, in which a pump support is formed in a plate shape on top of a container body and the pump is mounted on the pump support, wherein the pump is formed of a piston, a piston ring, a cylinder, and a suction valve plate as used in the conventional art; the stroke of the pump is reduced to 1.5-2.5 mm while the ratio of the stroke of the pump to the inner diameter of the cylinder is changed from 1:1-1:3 as in the conventional art to 1:5.5-1:13, thereby maximizing a content accommodating space in the main body of the container; a bushing is coupled to the upper portion of the cylinder of the pump, the end portion of the bushing being formed in a round shape, and a clearance of 0.3-1.2 mm is formed between the bushing and a vertical moving member so that the vertical moving member can flexibly move in the bushing; and the stroke of the pump is shortened in such a manner whereby a cosmetics pumping method is not restricted to pressing the center of a discharge plate, but allows a cosmetic material to be easily discharged even when any part of the discharge plate is pressed.

### CROSS-REFERENCE TO RELATED APPLICATION

This application claims the benefit of Korean application No. 10-2015-0109616, filed on Aug. 3, 2015 with the Korean Intellectual Property Office, the disclosure of which is incorporated herein by reference.

### TECHNICAL FIELD

The present invention relates to a compact container having a short stroke pump and a ring button member and, more particularly, to a compact container having a short stroke pump and a ring button member, in which a pump support is formed in a plate shape on top of a container body and the pump is mounted on the pump support, wherein the pump is formed of a piston, a piston ring, a cylinder, and a suction valve plate as used in the conventional art; the stroke of the pump is reduced to 1.5-2.5 mm while the ratio of the stroke of the pump to the inner diameter of the cylinder is changed from 1:1-1:3 as in the conventional art to 1:5.5-1:13, thereby maximizing a content accommodating space in the main body of the container; a bushing is coupled to the upper portion of the cylinder of the pump, the end portion of the bushing being formed in a round shape, and a clearance of 0.3-1.2 mm is formed between the bushing and a vertical moving member so that the vertical moving member can flexibly move in the bushing; and the stroke of the pump is shortened in such a manner whereby a cosmetics pumping method is not restricted to pressing the center of a discharge plate, but allows a cosmetic material to be easily discharged even when any part of the discharge plate is pressed.

### BACKGROUND ART

Color cosmetics, which are used to beautifully adorn the skin of a user by making the appearance beautiful, are classified into a base makeup used for making a skin color uniform and covering a defect and a point makeup used for partially enhancing a three-dimensional effect of a lip, eyes, or nails. The base makeup includes a makeup base, a foundation and a powder, and the point makeup includes a lipstick, an eye liner, and mascara.

The foundation is classified into solid-type foundation, liquid-type foundation and gel-type foundation according to a type of cosmetic contents. In case of the solid-type foundation, although the solid-type foundation has a good cover effect, the makeup is united when the makeup is refreshed. In case of the liquid-type foundation, although the liquid-type foundation gives a good close contact feel, the persistency is weak. Thus, in recent years, the number of customers who prefer the gel-type foundation, which has a considerable persistency and provides a good feeling when it is applied to the skin, has been increased.

Therefore, there is a need to develop a container for gel-type foundation. Generally, the gel-type foundation, which is filled into a glass container or a tube-type container, is used in such a manner that the user takes some foundation on user's hands for use or squeezes foundation from the container and then, applies the foundation on the user's skin by using a puff or user's hands.

However, according to the related art, since the user gets cosmetics on user's hand whenever using the cosmetics, it is inconvenient to wash hands every time after use. In addition, as the hands coated with cosmetics are washed, the cosmetics are wasted.

To solve the above mentioned problems, as shown in FIG. 1, the applicant has disclosed a compact container having airless pump in Korean Registered Utility Model No. 20-0461424. In the prior art, a gel cosmetic is filled in a container body and a pump is operated by pressing a button to discharge the gel cosmetic onto a discharge plate, then a puff may be used so that the cosmetic is not smeared on the hand when the gel cosmetic is used.

The pump 100 of the related art includes a cylinder 101, a piston 102, a piston ring 103, a suction valve plate 104, an up/down movement member 105 and a bushing 106.

However, in the prior art, the pump 100 is installed in an inner center of the container body and is structurally formed in such a manner that the pump comes into contact with a bottom surface of the container body, so the pump occupies a large portion in the container body and the volume, in which a range for forming a content accommodation space is reduced, thus the amount of contents accommodated in the container body is reduced and the cosmetic may be used for only a short period of time.

In general, the pump 100 used for conventional cosmetic products has a stroke distance of 3.0 mm to 6.3 mm and the ratio between the stroke distance of the pump 100 and the inner diameter of the cylinder 101 is 1:1 to 1:3. To solve the above-mentioned problems, the conventional structure, in which the pump is installed inside the container body, is needed to be changed such that the pump is installed on a top of the container body to enlarge the content accommodation space in the container body.

In addition, in the pump 100 of the related art, the interval between the up/down movement member 105 and the bushing 106 is tightly formed so that the pump 100 is operated only when the center axis of the piston 102 and the center axis of the cylinder 101 match with each other to induce the up/down movement member 105 to move vertically, however, the up/down movement member 105 becomes inclined when the central part of the pump is not pressed when the user operates the pump 100, so the up/down movement member 105 becomes trapped in the bushing 106 and the pump becomes inoperable.

In addition, in the related art, the center axis of the piston 102 and the center axis of the cylinder 101 are required to match with each other, so when the user presses the discharge plate to discharge the contents, the pressing location is limited, thus the user is required to vertically press the central part of the discharge plate to pump the cosmetic, so the pump is inconvenient to use.

### DISCLOSURE

### Technical Problem

To solve the above problems, the present invention provides a compact container having a short stroke pump and a ring button member, in which a pump support is formed in a plate shape on top of a container body and the pump is mounted on the pump support, wherein the pump is formed of a piston, a piston ring, a cylinder, and a suction valve plate as used in the conventional art; the stroke of the pump is reduced to 1.5-2.5 mm while the ratio of the stroke of the pump to the inner diameter of the cylinder is changed from 1:1-1:3 as in the conventional art to 1:5.5-1:13, thereby maximizing a content accommodating space in the main body of the container.

In addition, the present invention provides a compact container having a short stroke pump and a ring button member, in which a bushing is coupled to the upper portion of the cylinder of the pump, the end portion of the bushing being formed in a round shape, and a clearance of 0.3-1.2 mm is formed between the bushing and a vertical moving member, so that the vertical moving member can flexibly move in the bushing; and the stroke of the pump is shortened in such a manner whereby a cosmetics pumping method is not restricted to pressing the center of a discharge plate, but allows a cosmetic material to be easily discharged even when any part of the discharge plate is pressed.

Further, the present invention provides a compact container having a short stroke pump and a ring button member, in which a ring-shaped ring button member is provided below a discharge plate, pressure grooves are formed on two spots on a lower end of the ring button member which face each other in a diagonal direction, and a distribution plate is formed below the ring button member, wherein pressure protrusions are formed on two spots on an outer side of the distribution plate which face each other in a diagonal direction so as to correspond to the positions of the pressure grooves of the ring button member, and a content discharge pathway is formed by coupling the discharge plate to the distribution plate, such that the pressure groove formed in the diagonal direction of the ring button member presses the upper portion of the pressure protrusion of the distribution plate even though the ring button member is pressed in an inclined state when the ring button member is pressed to discharge the contents, thus the distribution plate vertically presses the pump.

### Technical Solution

The present invention provides a compact container having a short stroke pump and a ring button member, the compact container including: an inner container (30) formed therein with a content accommodation space (31);

a pump support (40) coupled to an upper portion of the inner container (30) to seal the inner container (30);

a pump (50) installed at a central upper portion of the pump support (40) to pump contents;

a distribution plate (60) coupled to an upper portion of the pump (50) and having pressure protrusions (61) formed on two spots of an outer side of the distribution plate (60) which face each other in a diagonal direction; and

a ring button member (70) coupled to an upper portion of the distribution plate (60) and having pressure grooves (71) formed on two spots of a lower end of the ring button member (70) which face each other in a diagonal direction, wherein

a stroke distance of the pump (50) is 1.5 mm to 3.0 mm, and the ratio of the stroke distance to an inner diameter of a cylinder (51) is 1:5 to 1:13.

In addition, the cylinder (51) of the pump (50) is integrally formed at a center of the pump support (40).

In addition, the pump (50) includes: the cylinder (51) formed in a bottom surface thereof with a content suction hole (58); a suction valve plate (52) mounted on the bottom surface of the cylinder (51) to selectively open or close the content suction hole (58); a bushing (53) coupled to an outer side of the cylinder (51), such that the bushing (53) is placed on an upper end of the cylinder (51); a piston (55) provided at an inner side of the cylinder (51); a piston ring (56) fitted to an outer side of the piston (55) and coming into close contact with an inner side surface of the cylinder (51); an up/down movement member (57) coupled to an inner peripheral surface of the piston (55) to move up and down; and an elastic member (54) for elastically supporting the up/down movement member (57).

In addition, an inner end of an inner horizontal extension piece (532) of the bushing (53) is round.

In addition, a gap (59) of 0.3 mm to 1.2 mm is formed between the inner horizontal extension piece (532) of the bushing (53) and an outer extension protrusion wheel (572) of the up/down movement member (57) to allow the up/down movement member (57) to flexibly move in the bushing (53).

In addition, an upper portion of the piston ring (56) is opened outward such that an inside of the cylinder (51) is closed by the piston ring 56 even when the up/down movement member (57) is pressed while being inclined to one direction, thereby normally operating the pump (50), an upper outer side of the piston ring (56) is closely fitted into the outer extension protrusion wheel (572) of the up/down movement member (57), and a piston wing (561) of the piston ring (56) comes into close contact with the inner side surface of the cylinder (51).

In addition, the ring button member (70) is formed in a ring shape, a press button (72) is formed on one side of the ring button member (70), and an axial protrusion (73) is formed on an opposite outer side of the press button (72).

In addition, the pressure protrusion (61) of the distribution plate (60) is fitted into the pressure groove (71) of the ring button member (70), such that pumping is performed even when the ring button member (70) is pressed or an upper surface of the distribution plate (60) is pressed.

### Advantageous Effects

According to the compact container having the short stroke pump and the ring button member of the present invention, a pump support is formed in a plate shape on top of a container body and the pump is mounted on the pump support, wherein the pump is formed of a piston, a piston ring, a cylinder, and a suction valve plate as used in the conventional art; the stroke of the pump is reduced to 1.5-2.5 mm while the ratio of the stroke of the pump to the inner diameter of the cylinder is changed from 1:1-1:3 as in the conventional art to 1:5.5-1:13, thus a content accommodating space in the main body of the container can be maximized.

In addition, according to the compact container having the short stroke pump and the ring button member of the present invention, a bushing is coupled to the upper portion of the cylinder of the pump, the end portion of the bushing being formed in a round shape, and a gap of 0.3-1.2 mm is formed between the bushing and a vertical moving member so that the vertical moving member can flexibly move in the bushing; and the stroke of the pump is shortened in such a manner whereby a cosmetics pumping method is not restricted to press the center of a discharge plate, but a cosmetic material can be easily discharged even when any part of the discharge plate is pressed.

Further, according to the compact container having the short stroke pump and the ring button member of the present invention, a ring-shaped ring button member is provided below a discharge plate, pressure grooves are formed on two spots on a lower end of the ring button member which face each other in a diagonal direction, and a distribution plate is formed below the ring button member, wherein pressure protrusions are formed on two spots on an outer side of the distribution plate which face each other in a diagonal direction so as to correspond to the positions of the pressure grooves of the ring button member, and a content discharge pathway is formed by coupling the discharge plate to the distribution plate, such that the pressure groove formed in the diagonal direction of the ring button member presses the upper portion of the pressure protrusion of the distribution plate even though the ring button member is pressed in an inclined state when the ring button member is pressed to discharge the contents, thus the distribution plate can vertically press the pump.

### DESCRIPTION OF DRAWINGS

FIG. 1 shows a conventional compact container having an airless pump.

FIG. 2 is a perspective view showing a compact container having a short stroke pump and a ring button member according to the present invention.

FIG. 3 is an exploded perspective view showing a compact container having a short stroke pump and a ring button member according to the present invention.

FIG. 4 is a sectional view taken along line A-A of a compact container having a short stroke pump and a ring button member according to the present invention.

FIG. 5 is a sectional view taken along line B-B of a compact container having a short stroke pump and a ring button member according to the present invention.

FIG. 6 is a sectional view taken along line A-A and showing a state of pressing a compact container having a short stroke pump and a ring button member according to the present invention.

FIG. 7 is a sectional view taken along line B-B and showing a state of pressing a compact container having a short stroke pump and a ring button member according to the present invention.

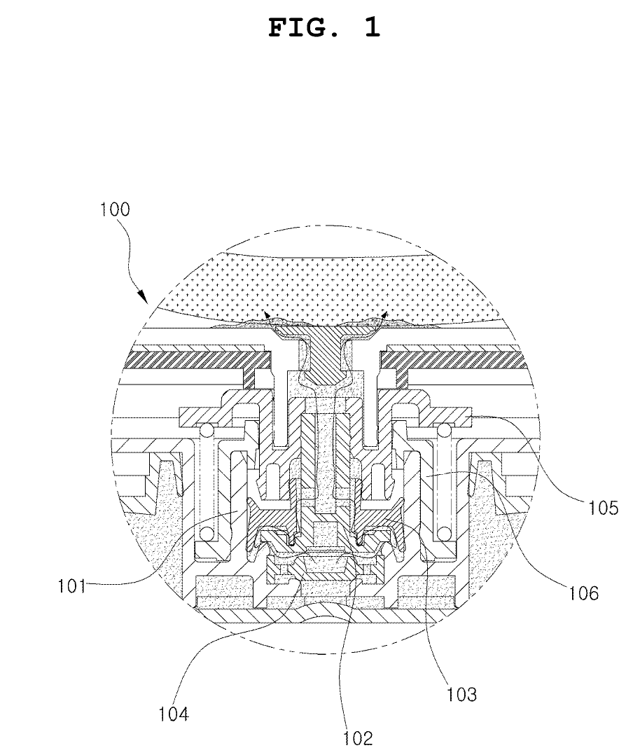

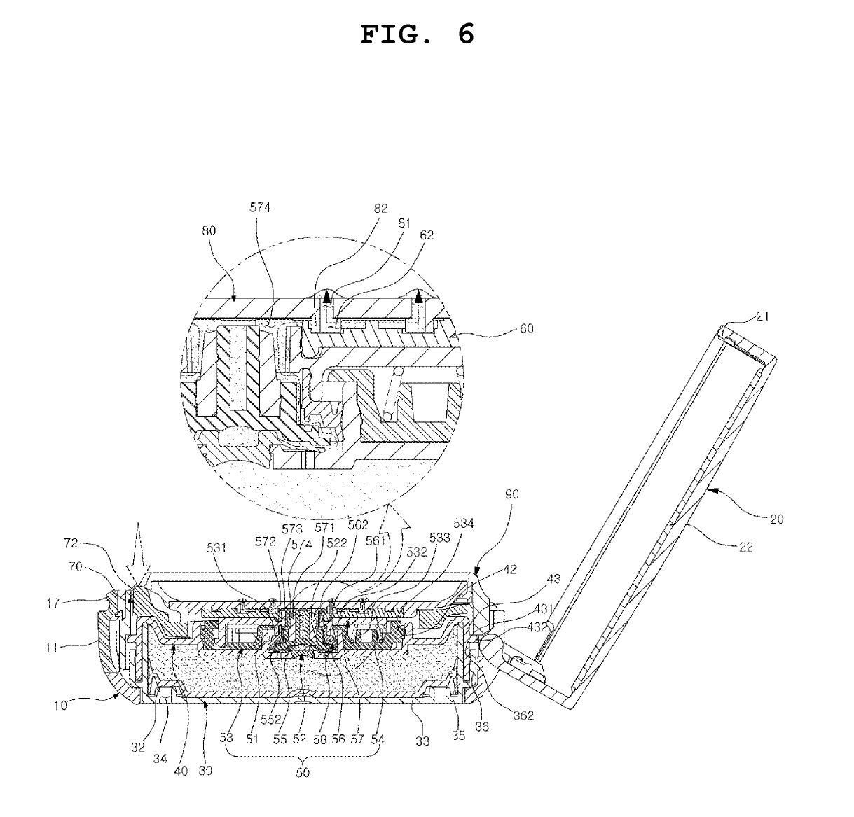

FIG. 6 is a sectional view taken along line A-A and showing a state of releasing the press on a compact container having a short stroke pump and a ring button member according to the present invention.

### BEST MODE

### Mode for Invention

Embodiments of the compact container having the short stroke pump and the ring button member according to the present invention will be described with reference to the accompanying drawings.

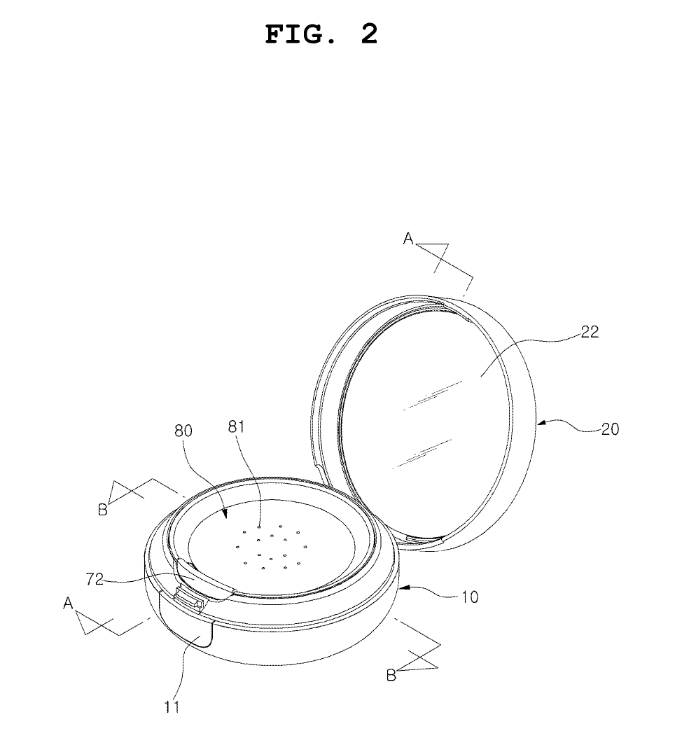

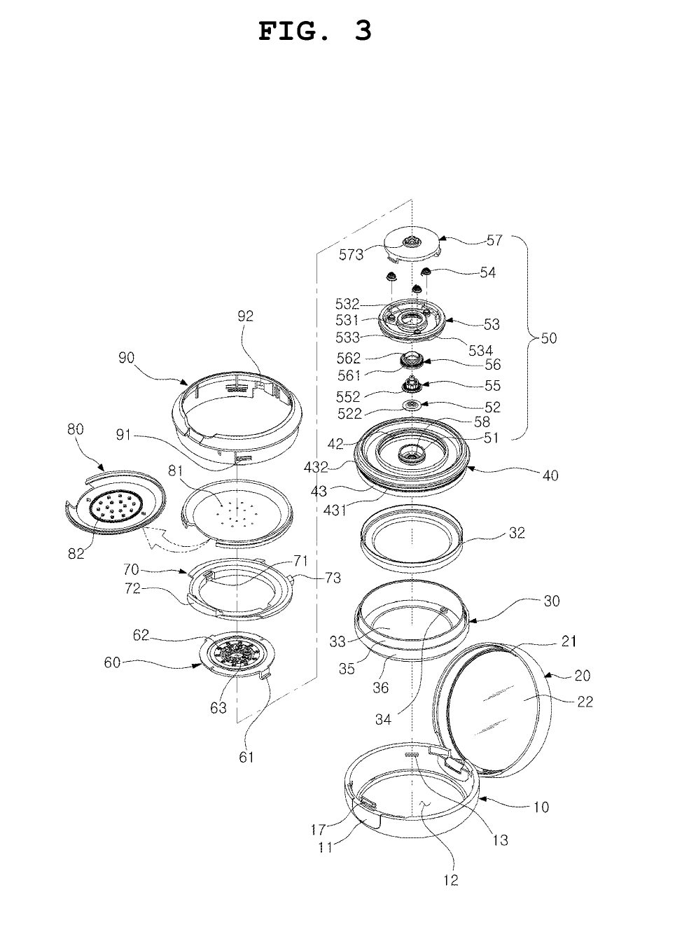

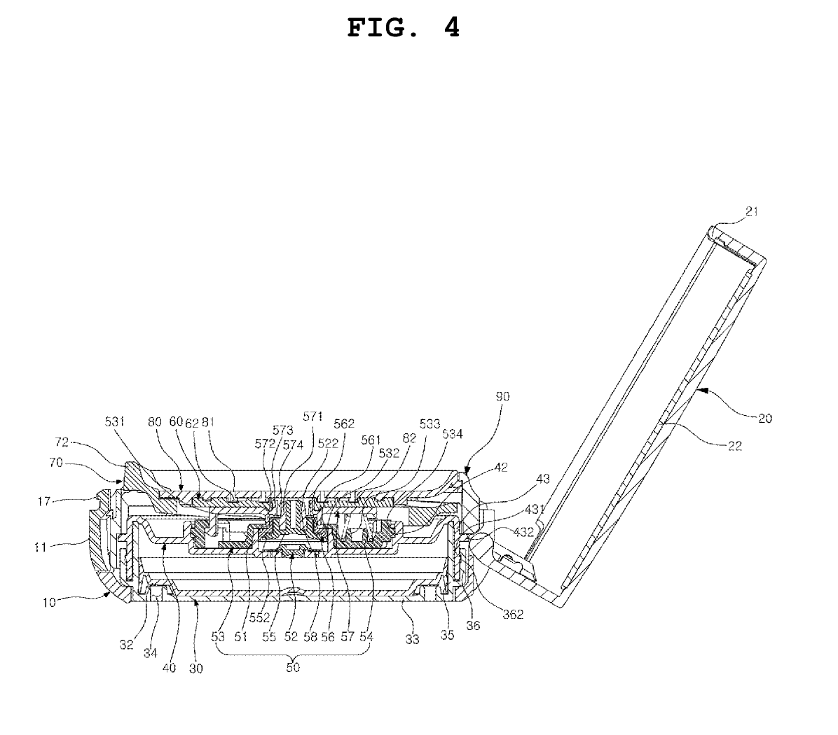

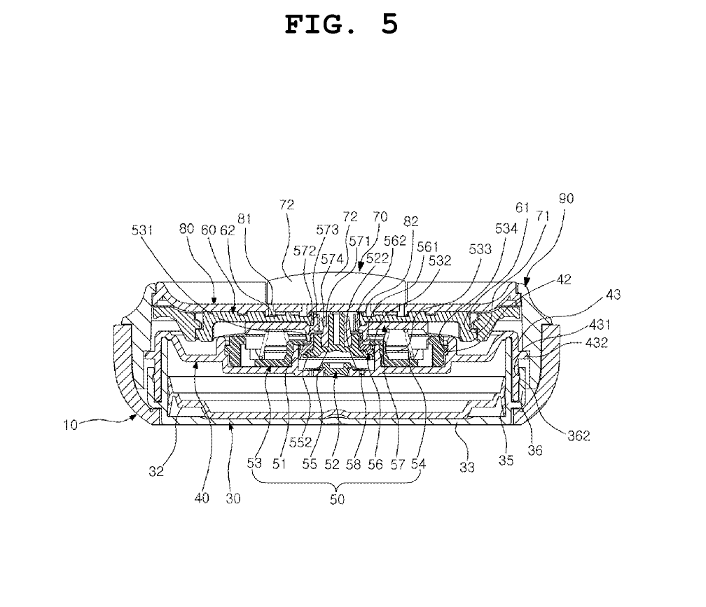

FIG. 2 is a perspective view showing a compact container having a short stroke pump and a ring button member according to the present invention. FIG. 3 is an exploded perspective view showing a compact container having a short stroke pump and a ring button member according to the present invention. FIG. 4 is a sectional view taken along line A-A of a compact container having a short stroke pump and a ring button member according to the present invention. FIG. 5 is a sectional view taken along line B-B of a compact container having a short stroke pump and a ring button member according to the present invention.

The compact container having the short stroke pump and the ring button member according to an embodiment of the present invention and including a container body 10 formed on one side thereof with a button 11, and a container lid 20 hinged to one side of the container body 10 so as to be opened and closed, comprises: an inner container 30 formed therein with a content accommodation space 31; a pump support 40 coupled to an upper portion of the inner container 30 to seal the inner container 30; a pump 50 installed at a central upper portion of the pump support 40 to pump contents; a distribution plate 60 coupled to an upper portion of the pump 50 and having pressure protrusions 61 formed on two spots of an outer side of the distribution plate 60 which face each other in a diagonal direction; and a ring button member 70 coupled to an upper portion of the distribution plate 60 and having pressure grooves 71 formed on two spots of a lower end of the ring button member 70 which face each other in a diagonal direction, wherein a stroke distance of the pump 50 is 1.5 mm to 3.0 mm, and the ratio of the stroke distance to an inner diameter of a cylinder 51 is 1:5 to 1:13.

The container body 10 is formed therein with an inner container accommodation space 12 for accommodating the inner container 30, and formed on an inner side surface thereof with a mount protrusion 13.

A button 11 is formed on one side of the container body 10, and a latching protrusion 17 which is easily retracted by a pressing action of the user protrudes from an upper side of the button 11.

The container lid 20 opens and closes the container body 10, and a protrusion-shaped hook 21 is formed, on one side of the container lid 20, at a position corresponding to the latching protrusion 17 of the container body 10 and fastened to the latching protrusion 17 of the container body 10.

In addition, a mirror 22 is provided on an inner side of the container lid 20 so that the user can easily put makeup.

The inner container 30 is provided therein with a pushing plate 32 for pushing the contents upward, and the pushing plate 32 comes in close contact with an inner side surface of the inner container 30.

The inner container 30 includes an inner container bottom surface 33, an inner wall 35 upwardly extending from the inner container bottom surface 33, and an outer wall 36 spaced apart at a predetermined interval and outwardly extending from the inner wall 35.

The inner container 30 is inserted into an inner container insertion space of the container body 10, and a coupling groove 362 is formed on an inner periphery of the outer wall 36 of the inner container 30.

In addition, an air flow hole 34 for introducing external air is formed in an inner container bottom surface 33 of the inner container 30.

The pump support 40 is formed in a plate shape and coupled to an upper portion of the container 30 to seal the container 30.

A cylinder 51 is integrally formed at the center of the pump support 40, the cylinder 51 is formed on an outer side thereof with a bushing coupling groove 42 to which the bushing 53 of the pump 50 is coupled, and a lower extension protrusion wheel 43 downwardly extends from an outer side of the bushing coupling groove 42.

A coupling protrusion 431 is formed on an outer periphery of the lower extension protrusion wheel 43 of the pump support 40 so as to be coupled to the coupling groove 362 of the inner container 30, and a step 432 protrudes from an upper side of the coupling protrusion 431.

The pump 50 pumps the contents and includes the cylinder 51, the suction valve plate 52, the piston 55 and the piston ring 56 as in the conventional pump, however, the pump 50 is installed on an upper portion of the pump support 40 to maximize the area of a content accommodation space 31 in the inner container 30 unlike the conventional pump, and has the stroke distance between 1.5 mm to 3.0 mm and the ratio of the stroke distance to the inner diameter of the cylinder 51 between 1:5 to 1:13, so that the pump 50 has a remarkably short stroke distance and a large inner diameter of the cylinder 51 as compared with those of the conventional pump.

Table 1 below shows the ratio between the stroke distance and the inner diameter of the cylinder according to the conventional pump.

TABLE 1

| stroke | inner | | |
|---|---|---|---|
| distance of | diameter of | | discharge |
| pump (mm) | cylinder (mm) | ratio | amount (cc) |
| 6.3 | 7.2 | 1:1.143 | 0.256 |
| 5.8 | 8.4 | 1:1.448 | 0.321 |
| 5.2 | 7.6 | 1:1.462 | 0.236 |
| 4 | 7.66 | 1:1.915 | 0.184 |
| 3.1 | 9.3 | 1:3 | 0.191 |
| 3.2 | 9.7 | 1:3.031 | 0.236 |

As shown in Table 1, the conventional pump has the stroke distance of 3.1 mm to 6.3 mm, and the ratio between the pump stroke and the cylinder inner diameter of 1:1 to 1:3.

When the conventional pump is applied to a container such as a compact container having a short vertical length and a long lateral length, there is a problem in that the conventional pump is equipped in the content accommodation space formed in the container body and thus occupies a large area of the content accommodation space.

To solve the above problems, according to the compact container having the short stroke pump and the ring button member of the present invention, the pump 50 is installed on the upper portion of the plate-shaped pump support 40 after changing the ratio between the stroke distance and the inner diameter of the cylinder 51 into the range of 1:5 to 1:13 so as to reduce the stroke distance of the pump 50 into a range between 1.5 mm and 3.0 mm and enlarge the inside diameter of the cylinder 51, such that the content accommodation space 31 of the inner container 30 can be maximally utilized.

The pump 50 includes: a cylinder 51 formed at a central upper side of the pump support 40 and having a content suction hole 58 formed in a bottom surface of the cylinder 51; a suction valve plate 52 mounted on the bottom surface of the cylinder 51 to selectively open or close the content suction hole 58; a bushing 53 coupled to an outer side of the cylinder 51, such that the bushing 53 is placed on an upper end of the cylinder 51; an elastic member 54 mounted on the bushing 53 or on the pump support 40 to elastically support the up/down movement member 57; a piston 55 provided at an inner side of the cylinder 51; a piston ring 56 fitted to an outer side of the piston 55 and coming into close contact with an inner side surface of the cylinder 51; an up/down movement member 57 coupled to an inner peripheral surface of the piston 55 to move up and down.

An inner extension protrusion wheel 571 coupled to the inside of the piston 55 extends from a lower center of the up/down movement member 57, and an outer extension protrusion wheel 572, which is spaced apart from an outside of the inner extension protrusion wheel 571 at a predetermined interval and fitted to an outer side of the piston ring 56, extends.

In addition, an upper extension protrusion wheel 573 into which the distribution plate 60 is inserted extends from an upper center of the up/down movement member 57.

A plurality of discharge paths 574 through which the pumped contents pass are formed between the inner extension protrusion wheel 571 and the outer extension protrusion wheel 572 of the up/down movement member 57.

A through hole 531 through which the outer extension protrusion wheel 572 of the up/down movement member 57 passes is formed at a center of the bushing 53, an inner horizontal extension piece 532 extends inside the through hole 531, a plurality of elastic member accommodation parts 533 are formed outside the through hole 531, and an outer horizontal extension piece 534 fitted to a bushing coupling groove 42 of the pump support 40 is formed outside the elastic member accommodation part 533.

An inner end of an inner horizontal extension piece 532 of the bushing 53 is formed in a round shape.

In addition, a gap 59 of 0.3 mm to 1.2 mm is formed between the inner horizontal extension piece 532 of the bushing 53 and an outer extension protrusion wheel 572 of the up/down movement member 57 to allow the up/down movement member 57 to flexibly move in the bushing 53.

In other words, an upper portion of the piston ring 56 of the pump 50 is opened outward, and a close contact protrusion wheel 562 is formed on an outer side at the upper end of the piston ring 56, such that an upper outer side of the piston ring 56 is closely fitted into the outer extension protrusion wheel 572 of the up/down movement member 57, and a piston wing 561 of the piston ring 56 comes into close contact with the inner side surface of the cylinder 51, thus an inside of the cylinder 51 is sealed by the piston ring 56, thereby normally operating the pump 50 even when the up/down movement member 57 is pressed while being inclined to one direction.

Accordingly, even though the up/down movement member 57 is inclined when the user presses a portion beyond a center of the discharge plate 60 without vertically pressing the center of the discharge plate 60, the piston ring 56 is normally operated inside the cylinder 51, so that the contents may be easily pumped.

A pair of pressure protrusion 61 are formed on an outer edge of the distribution plate 60, a content discharge pathway 62 through which the contents move is formed on the upper surface of the distribution plate 60, and a coupling hole 63, to which the upper extension protrusion wheel 573 of the up/down movement member 57 is fitted, is formed at the center of the distribution plate 60.

The pressure protrusion 61 of the distribution plate 60 is formed to correspond to the position of the pressure groove 71 of the ring button member 70 and fitted in the pressure groove 71 of the ring button member 70.

In addition, preferably, the upper surface of the pressure protrusion 61 of the distribution plate 60 has an arc shape.

The ring button member 70 is formed in a ring shape, a press button 72 upwardly protrudes from one side of the ring button member 70, and an axial protrusion 73 is formed on an outer side opposite to the press button 72.

A pair of pressure grooves 71 are formed at positions perpendicular to the direction of connecting the pressure button 72 to the axial protrusion 73.

In addition, preferably, the pressure groove 71 of the ring button member 70 is semicircular or square.

In other words, the upper surface of the pressure protrusion 61 of the distribution plate 60 is formed in an arc shape, the pressure groove 71 of the ring button member is formed in a semicircular or square shape, thereby fitting the pressure protrusion 61 into the pressure groove 71, such that even though the ring button member 70 is pressed in an inclined state when the user presses the ring button member 70 to discharge the cosmetics, the pressure groove 71 of the ring button member 70 vertically press the distribution plate 60 while sliding on the arc-shaped upper surface of the pressure protrusion 61 of the distribution plate 60, thus the distribution plate 60 can uniformly press the pump 50.

A discharge plate 80 is provided on the upper side of the distribution plate 60, in which the discharge plate 80 is attached to the upper surface of the distribution plate 60 and simultaneously mounted on an upper portion of the ring button member 70, and has a plurality of discharge holes 81.

A discharge protrusion wheel 82 mounted on the content discharge pathway 62 of the distribution plate 60 extends from a lower side of the discharge hole 81, in which the discharge protrusion wheel 82 is opened at one side of an outer periphery thereof such that the contents can pass through.

Preferably, the discharge plate 80 is attached to the upper surface of the distribution plate 60 by using a double adhesive tape.

There is further provided a fixation member 90 coupled to the upper portion of the container body 10 to fix and prevent the inner container 30, the distribution plate 60, the discharge plate 80, and the ring button member 70 from being separated.

A mount groove 91 is formed on an outer periphery of the fixation member 90 and coupled to the mount protrusion 13 of the container body 10.

A lower end of the fixation member 90 presses and fixes an upper surface of the step 432 of the pump support 40, and an axial coupling groove 92 is formed on one side of an outer periphery of the fixation member 90, so that the axial protrusion 73 of the ring button member 70 is fitted into the axial coupling groove 92.

A method of assembling the compact container having the short stroke pump and the ring button member configured in the above manner will be described as follows.

In order to assemble the compact container having the short stroke pump and the ring button member according to the present invention, at first, as shown in FIGS. 3 and 4, the pushing plate 32 is inserted into the inner container 31, the cosmetics are injected into the inner container 30, the pump support 40 is coupled to the upper portion of the inner container 30, and the pump 50 is installed on the upper portion of the pump support 40.

Next, the inner container 30 assembled in the above manner is inserted into the container body 10 having one side hinged to the container lid 20.

Next, the distribution plate 60 is coupled to the upper portion of the up/down movement member 57 of the pump 50, in which the upper extension protrusion wheel 573 of the up/down movement member 336 is inserted into the coupling hole 63 of the distribution plate 50.

Next, the ring-shaped ring button member 70 is mounted on the distribution plate 60, in which the pressure protrusions 61 of the distribution plate 60 are fitted into the pressure grooves 71 of the ring button member 70.

Next, the discharge plate 80 is mounted on the distribution plate 60 and the ring button member 70, in which the discharge protrusion wheels 82 of the discharge plate 80 are mounted on the content discharge pathways 62 of the distribution plate 60.

Finally, the fixation member 90 is coupled onto the discharge plate 80, in which the mount protrusion 13 of the container body 10 is coupled to the mount groove 91 of the fixation member 90, and the axial protrusion 73 of the ring button member 70 is fitted into the axial coupling groove of the fixation member 90, thus the assembly of the compact container having the short stroke pump and the ring button member according to the present invention is finished.

A using method of the compact container having the short stroke pump and the ring button member assembled in the above method will be described with reference to the accompanying drawings.

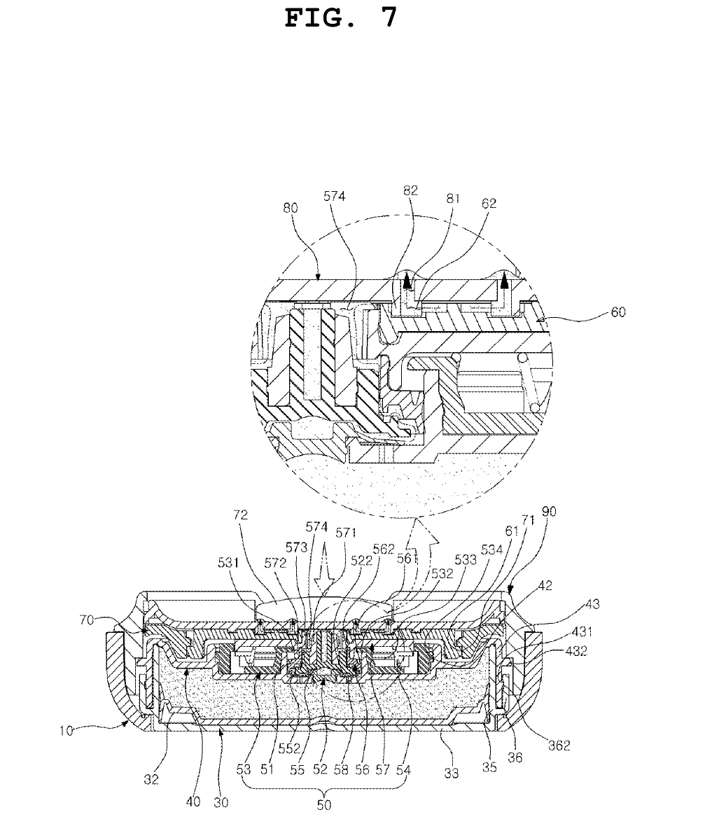

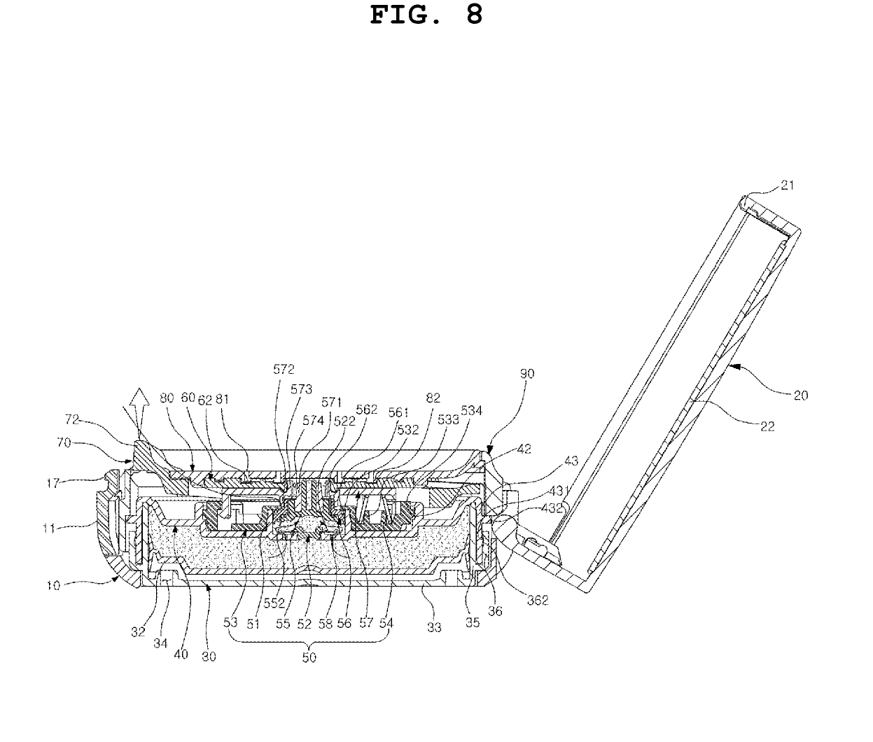

FIG. 6 is a sectional view taken along line A-A and showing a state of pressing a compact container having a short stroke pump and a ring button member according to the present invention. FIG. 7 is a sectional view taken along line B-B and showing a state of pressing a compact container having a short stroke pump and a ring button member according to the present invention. FIG. 6 is a sectional view taken along line A-A and showing a state of releasing the press on a compact container having a short stroke pump and a ring button member according to the present invention.

In order to use the compact container having the short stroke pump and the ring button member according to the present invention, at first, the container lid 20 is opened from the container body 10 by pressing the button 11.

Next, as shown in FIGS. 6 and 7, the press button 72 of the ring button member 70 or the upper surface of the discharge plate 80 is pressed.

When the press button 72 is pressed, the ring button member 70 moves downward while being inclined, and the distribution plate 60 mounted below the button member 70 also moves downward.

Herein, even though the ring button member 70 is pressed in an inclined state, the pressure groove 71 of the ring button member 70 vertically presses the distribution plate 60 while sliding on the arc-shaped upper surface of the pressure protrusion 61 of the distribution plate 60, thus the distribution plate 60 can uniformly press the pump 50.

In addition, when the discharge plate 80 is directly pressed, the distribution plate 60 coupled to the discharge plate 80 is pressed and moves downward together, and the up/down movement member 57 of the pump 50 coupled to the distribution plate 60 moves downward.

The piston 55 coupled to the lower side of the up/down movement member 57 also moves downward due to the downward movement of the up/down movement member 57, in which the piston ring 56 comes in close contact with the inner side surface of the cylinder 51, thus only the piston 55 moves downward, thereby generating a gap between the piston 55 and the piston ring 56, so that the discharge path for the cosmetics is generated.

Then, when the up/down movement member 57 is continuously pressed, the piston ring 56 comes in contact with the up/down movement member 57 and move downward together with the piston 55, thereby reducing the volume inside the cylinder 51, thus the cosmetics accommodated in the cylinder 51 flow out between the piston 55 and the piston ring 56, pass through the discharge paths 574 of the up/down movement member 57, pass through the discharge pathway 62 of the distribution plate 60, and is discharged to the discharge hole 81 of the discharge plate 80.

Simultaneously, the suction valve plate 52 closes the content suction hole 58 formed on the bottom surface of the cylinder 51 caused by discharge pressure in the cylinder 51.

Then, as shown in FIG. 8, when the pressure against the press button 72 of the ring button member 70 or the discharge plate 80 is released, the up/down movement member 57 moves upward due to the elasticity of the elastic member 54 which elastically supports the up/down movement member 57, and the piston 55 coupled to the lower portion of the up/down movement member 57 moves upward. Herein, an extension protrusion wheel 552 formed on an outer side of the lower end of the piston 55 lifts the piston ring 56 upward, thereby blocking the gap between the piston 55 and the piston ring 56, such that the piston 55 moves upward together with the piston ring 56, thus the volume inside the cylinder 51 increases, therefore vacuum pressure is generated.

A suction valve blade 522 of the suction valve plate 52 is lifted by the vacuum pressure generated in the cylinder 51, thereby opening the content suction hole 58 formed on the bottom surface of the cylinder 51, thus the cosmetics accommodated in the inner container 30 are introduced into the cylinder 51 through the content suction hole 58, and simultaneously the pushing plate 32 installed inside the inner container 30 moves upward.

The above description of the present invention is just one embodiment for carrying out the compact container having the short stroke pump and the ring button member, and the present invention is not limited thereto. Preferred embodiments have been proposed and set forth in the aforementioned description, however the present invention should not be construed as limited thereto, and it will be apparent to those having ordinary skill in the art in that many different substitutions, deformations and modifications are available within the scope without departing from the invention.

### DESCRIPTION OF REFERENCE NUMERALS

| | |
|---|---|
| 10: container body | 11: button |
| 12: inner container accommodation space | |
| 13: mount protrusion | 20: container lid |
| 21: hook | 22: mirror |
| 30: inner container | 32: pushing plate |
| 34: air flow hole | 40: pump support |
| 50: pump | 51: cylinder |
| 53: bushing | 60: distribution plate |
| 61: pressure protrusion | 70: ring button member |
| 71: pressure groove | 80: discharge plate |
| 81: discharge hole | 90: fixation member |

1. A compact container having a short stroke pump and a ring button member, the compact container comprising:
an inner container (30) formed therein with a content accommodation space (31);
a pump support (40) coupled to an upper portion of the inner container (30) to seal the inner container (30);
a pump (50) installed at a central upper portion of the pump support (40) to pump contents;
a distribution plate (60) coupled to an upper portion of the pump (50) and having pressure protrusions (61) formed on two spots of an outer side of the distribution plate (60) which face each other in a diagonal direction; and
a ring button member (70) coupled to an upper portion of the distribution plate (60) and having pressure grooves (71) formed on two spots of a lower end of the ring button member (70) which face each other in a diagonal direction, wherein
a stroke distance of the pump (50) is 1.5 mm to 3.0 mm, and a ratio of the stroke distance to an inner diameter of a cylinder (51) is 1:5 to 1:13.

2. The compact container of claim 1, wherein the cylinder (51) of the pump (50) is integrally formed at a center of the pump support (40).

3. The compact container of claim 1, wherein the pump (50) comprises:
the cylinder (51) formed in a bottom surface thereof with a content suction hole (58);
a suction valve plate (52) mounted on the bottom surface of the cylinder (51) to selectively open or close the content suction hole (58);
a bushing (53) coupled to an outer side of the cylinder (51), such that the bushing (53) is placed on an upper end of the cylinder (51);
a piston (55) provided at an inner side of the cylinder (51);
a piston ring (56) fitted to an outer side of the piston (55) and coming into close contact with an inner surface of the cylinder (51);
an up/down movement member (57) coupled to an inner peripheral surface of the piston (55) to move up and down; and
an elastic member (54) for elastically supporting the up/down movement member (57).

4. The compact container of claim 3, wherein an inner end of an inner horizontal extension piece (532) of the bushing (53) is rounded.

5. The compact container of claim 3, wherein a gap (59) of 0.3 mm to 1.2 mm is formed between the inner horizontal extension piece (532) of the bushing (53) and an outer extension protrusion wheel (572) of the up/down movement member (57) to allow the up/down movement member (57) to flexibly move in the bushing (53).

6. The compact container of claim 3, wherein an upper portion of the piston ring (56) is opened outward such that an inside of the cylinder (51) is sealed by the piston ring 56, thereby normally operating the pump (50) even when the up/down movement member (57) is pressed while being inclined to one direction, an upper outer side of the piston ring (56) is closely fitted into the outer extension protrusion wheel (572) of the up/down movement member (57), and a piston wing (561) of the piston ring (56) comes into close contact with the inner side surface of the cylinder (51).

7. The compact container of claim 1, wherein the ring button member (70) is formed in a ring shape, a press button (72) is formed on one side of the ring button member (70), and an axial protrusion (73) is formed on an opposite outer side of the press button (72).

8. The compact container of claim 1, wherein the pressure protrusion (61) of the distribution plate (60) is fitted into the pressure groove (71) of the ring button member (70), such that pumping is performed even when the ring button member (70) is pressed or an upper surface of the distribution plate (60) is pressed.
